(19) United States
(12) Patent Application Publication
(10) Pub. No.: US 2011/0222680 A1
(43) Pub. Date: Sep. 15, 2011

(54) SYSTEM AND METHOD FOR ROUTING TELEPHONE CONNECTIONS USING SHORT CODE DIALING

(75) Inventor: David Rawet, Tel Aviv (IL)

(73) Assignee: Intelligent Network Application Protocol Ltd., London (GB)

(21) Appl. No.: 12/720,422

(22) Filed: Mar. 9, 2010

(51) Int. Cl. H04M 3/42

(52) U.S. Cl. 379/216.01

(57) ABSTRACT

By establishing double star short dialing codes (short codes) a party may have assigned to it a two, three, four or five digit name or number that is easy to remember because it has only a few numbers. When that number is dialed, the number is directed to a special translator that translates the short code to the full number, or to a series of called numbers, for subsequent routing through the telephone network. Because of the shortage on the numbering plan, the short code is indicated to the telephone network by the calling user dialing a unique prefix combination of non-numeric digits. In one embodiment, a control digit within the short code indicates to the system also the length of the short code. In this manner, variable length short numbers can be utilized for telephone or SMS messaging routing purposes, thus expanding the existing dial plan for the short number purposes.

### TECHNICAL FIELD

This disclosure relates to telephone call routing and more particularly to systems and methods for routing telephone calls to their intended destinations using short code dialing in order to overcome the existing Numbering Plan limitations.

### BACKGROUND OF THE INVENTION

There is hardly a telephone user anywhere in the world who is unfamiliar with 800 number calling where the called party pays the bill. A service that allows call originators to place toll telephone calls to 800-service subscribers, from within specified rate areas, without a charge to the call originator. This “free” calling service, originally called Inward Wide Area Telephone Service or INWATS, has expanded beyond simply using 800 as a prefix. Over the years, prefixes such as 888, 877 and 866, have also been used to provide service. Numbers, such as, 855, 884, 833, 838, 880, 887, and 889 are reserved for future use.

In 1978, Roy P. Weber, then an inventor at Bell Telephone Laboratories, filed a patent application detailing how an 800 number would be translated for delivery to the proper called party. That application issued on Mar. 4, 1980 as U.S. Pat. No. 4,191,860 and is hereby incorporated herein by reference.

Vanity numbers, such as 1-800 INVENTION, were a natural outgrowth of the toll-free number system having the advantage of being easy to remember. In this example, the toll-free number would actually be 1-800-468-3684 and the last two letters (O and N) are simply dropped by the system. The vanity numbers have shown to be valuable. Wikipedia claims that vanity numbers increase response rates to advertisements by 30-60%. This makes sense because for most people remembering words (INVENTION) is much easier than remembering numbers (468-3684). This is so even though the word INVENTION has more characters than does the number 468-3684.

The problem is that there are only a limited availability of unique words. Unique in this sense meaning that when dialed on a telephone key pad they do not duplicate another word. For example, using a telephone keypad the name KAYWERP would yield the same numerical digits (529-9377) as would the word LAWYERS.

Another problem is the length of the digits that one must recall in order to dial a party. This become especially troublesome when dialing across country borders where other prefixes and country codes need to be added.

A still further problem is the length of the dialing string. For the North America Numbering Plan (NANP) there is a “1” followed by perhaps “800” (for calls) followed by a three digit exchange followed by four digits. This then yields a minimum of seven digits and a maximum of eleven digits with a possibility of ten digits in some cases. Thus, it is hard to secure an easily remembered number because of the fixed nature of the dialing plan and the fact that the number of digits required to reach a given number is dependant upon the relative locations of the caller and called parties.

Current short code usage is limited to the use of the *XX combination for activation, verification or deactivation of special features. Additionally, this short code usage is also currently used with some limitation with respect to an individual operator's shortened way for allowing the operator's customers to reach its customer service, or to reach local emergency assistance or to reach local radio stations. All of the known short code dialing situations are limited to single cellular operators in a limited geographical area.

This approach does not allow and does not facilitate for the solution of the need to expand the dial plan while also making it easy to remember a given number. The main problem that forces the numbering plan to go to more and more digits is the fact that the current numbering plan is quite limited and totally occupied.

### BRIEF SUMMARY OF THE INVENTION

By establishing a double star prefix to short dialing codes (short codes) a party may have assigned to it a two, three, four or five digit name or number that is easy to remember because it has only a few numbers. When that number is dialed, the number is directed to a special translator that translates the short code to the full number, or to a series of called numbers, for subsequent routing through the telephone network. Because of the shortage on the numbering plan, the short code is indicated to the telephone network by the calling user dialing a unique prefix combination of non-numeric digits. In one embodiment, a control digit within the short code indicates to the system also the length of the short code. In this manner, variable length short numbers can be utilized for telephone or SMS messaging routing purposes, thus expanding the existing dial plan for the short number purposes.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 shows one embodiment of the application of the concepts discussed herein in a telephone system;

FIG. 2 shows one embodiment of a star-star detect circuit used to facilitate star-star translation; and

FIG. 3 shows one embodiment of a method for controlling telephone routing using short code dialing.

### GENERAL DESCRIPTION

In the United States, geographic boundaries have been established called Local Access and Transport Areas or LATAs and one or more Local Exchange Carriers (LECs) can provide service within each LATA. A user obtains an 800 number from a Carrier and the carrier then specifies, in accordance with the user request, where any call using that 800 number is to be delivered.

When an 800 number is dialed, the local LEC that receives the dialed call directs the call to a service switching point (SSP) which then sends the call to a service control point (SCP). The SCP informs the SSP where to direct the call in accordance with a table as provided by the issuing carrier.

Once the SSP at the receiving LEC determines the destination of the call it is sent to the POP of the called parties LEC. Once the final determination of where the call is supposed to go is completed, the call is then routed to the subscriber's individual line or trunk lines. In a call center or contact center environment, the call is then typically answered by a telephone system known as an automatic call distributor (ACD) or private branch exchange (PBX).

One feature of toll-free calling is to route calls based on the location of the calling party. For example, if a caller is from a location “A” his/her 800 calls to a particular number will be routed to a location associated with location “A”, while calls to the same 800 number from location “B” could be routed to a different answering location, using a different destination number.

In this context, the numbers 0 to 9 are represented typically by unique combinations of tones, hence the nomenclature MF tones or MF digits. The typical dialing keypad has twelve buttons, each of which yields a distinct MF tone. Thus there are two buttons which, while producing MF tones, do not result in a number but, while not done today, can be dialed as part of the called number and act as a prefix to other numeric digits, thus expanding the existing numbering plan. These non-numeric digits are referred to as the asterisk (*) (herein called star) and the pound (#) buttons and are treated as non-numeric dialed digits. It is a known fact that central offices are able to detect these non-numeric signals and take them into account as part of the regular dialing. For short code service in accordance with one aspect of the invention, each short code customer is assigned a 3 to 6 digit short code prefixed by a unique non-numeric set of digits, such as double star (double asterisk) in a format such as **wXXX number which is dialed by callers to that customer. The called number is used to control the establishment of connections through the telephone switching system to a centralized database system for deriving all of the call routing, traffic measurement and network management data on calls to the short code customer. As used herein, the term star-star initiated calling connection compasses any calling connection initiated using a unique combination of non-numbers as part of the called number. Preferably, the unique combination would be the first two dialed digits, such as ** (star-star or double star).

In one embodiment, the w digit that comes immediately after the double star determines the length of the remaining digits. For example, for a w digit of the value of 2 the total length of the short code is 3 numbers following the **. For a w digit of the value of 3 or 4 the length of the short code will be 4 digits following the **. For a w digit of the value of 5 or 6 the length of the short code will be 5 digits following the **. For a w digit of the value of 6, 7, 8 or 9, the length of the short code will be 6 digits following the **. Of course, this arrangement is an example and a given length can be determined by any desired value of w.

Another system for determining variable length dialing codes could be that the digit immediately following the asterisk (star) or in some cases the actual number of stars could indicate the length of the dialed number. Thus, **3 could mean that there will be three more digits and **4 could mean that there will be four more digits. Thus, the dialed number **41234 would be proper while the dialed number **3123 would also be a proper number. Another example could be that ** means two digits will follow and *** means that three digits will follow, etc. Note that the length indicator could come at any place in the number chain and in some situations the number simply can be dialed and a star (or other unique non-number MF tone or combination of tones) added to the end to signify length. Thus, 123## could be a valid three-digit dialed number under some systems as would **1234* be a proper four-digit dialed number under other systems. As will be discussed, the important point is that the system must at some point recognize that no more digits are expected and to know which database to use for proper look up and translation.

The data is utilized to screen calls for short code service entitlement and for specifying a POTS (Plain Old Telephone Service) DDD (Direct Distance Dialing) number to which entitled calls are to be routed to the short code customer on a toll-free basis to the caller, or on a reduced charge basis as a further development of the numbering plan expansion. Data may be included in the database for specifying the busy/idle status and open/closed station condition of the preferred number. A series of alternate numbers for the short code service can also be stored in the database for routing calls to the desired destination whenever the preferred number is busy or closed. The destination numbers will be dialed one after the other until the call is answered or the call is terminated on a Voice Messaging system in order to get the calling party's call, in a way. Another possible behavior could be to route the call to a series of numbers and allow the call to be switched to the called destination that answers the call first.

The database is strategically located at one or more existing or newly deployed SCPs to serve a multitude of telephone offices and illustratively is one of several designed to serve as a distributed array for the entire United States. It is advantageously arranged for traffic measurements of calls to the short code customer on the basis of originating area code. These measurements enable the operator to analyze traffic patterns and short code number usage by area code for the end user, to obtain adequate recommendation for the numbers of lines and personnel for serving the calls, and to determine the recommendation for economic need for the short code service in that area. The SCP database measures the traffic by counting each call by the originating area code and by accumulating a count of all calls to the short code customer. When the latter exceeds a predetermined threshold per unit time, the database may manage the number of calls routed to the preferred and/or alternate numbers in such a way as to reduce the probability of ineffective call completion attempts due to mass calling of the short code customer. It does so by instructing the telephone system control (via the CCIS capability) to inhibit calls to the short code number for a prescribed period of time. This action relieves the telephone voice network, database and CCIS facilities from real time involvement on calls to extremely busy stations and makes them available for serving other destination calls.

As in the existing 800 translation table, the database comprises a first table in memory which includes a file of originating area codes (NPAs). Each such code is correlated in the file with an individual POTS number or with a series of POTS destination numbers * (for sequentially or simultaneously ringing those lines) when short code service is purchased by the enterprise customer for that area code. In response to a receipt of a dialed short code number and the call originating area code from a telephone system, the database examines its NPA file of originating area codes for screening the call to check whether the short code customer has requested to receive calls from that area code. Such a request is identified by the presence of an individual POTS number or with a series of POTS destination numbers in the same memory file as the received area code. The NPA file also comprises a counter which is incremented on each call attempt per originating area code.

The procedure for processing a short code call comprises a calling party dialing the **XXXX code of the desired short code customer. The local telephone office serving the calling station is responsive to the dialed number for routing the call to a toll office equipped with CCIS (Common Channel Interoffice Signaling) facilities and sending to that office the dialed number together with the prefix of the non-number dialed digits. The toll office for this case will serve as the SSP (Service Switching Point) and routinely identifies the area code from which the call originates and then sends it together with the dialed number over the CCIS direct signaling system to the database identified by the CCIS system from the dialed Short Code number (a process called Global Title Translation or GTT).

At the database, the received short code number is checked to ascertain that it is an active working number for the specific calling area. Next, in one embodiment, the file of the originating area code is located in the first memory table and the entitlement of the call to be made from that originating area is verified by extracting the POTS number of the series of numbers of the short code customer station designated to serve the call. The NPA file counter is then incremented to indicate a call attempt involving the originating area code.

Thereafter, the file of the assigned POTS number is located in the second memory table and the open/closed and busy/idle status of the destination station associated with that number may be examined. Upon determining that the station is open and idle, a CCIS message containing the assigned POTS number is sent from the database over the CCIS system to the toll office for enabling call connections to be established from that office through the toll switching network to the station associated with the POTS number. At about the same time, the counter in the POTS number file is incremented to accumulate data on traffic to that POTS number and to control call routing to it, during mass calling periods, when the number of calls exceed a predetermined threshold.

The call processing procedure is arranged to return CCIS messages from the database to the toll office to identify the destination dialing of a nonworking short code number, a call which is not authorized on a toll-free basis from that call originating area, and the busy or closed status of the short code station designated to serve the call.

The method is advantageously useful for database service on automated collect calling, toll call forwarding and other special service calls as hereinafter described.

### DETAILED DESCRIPTION

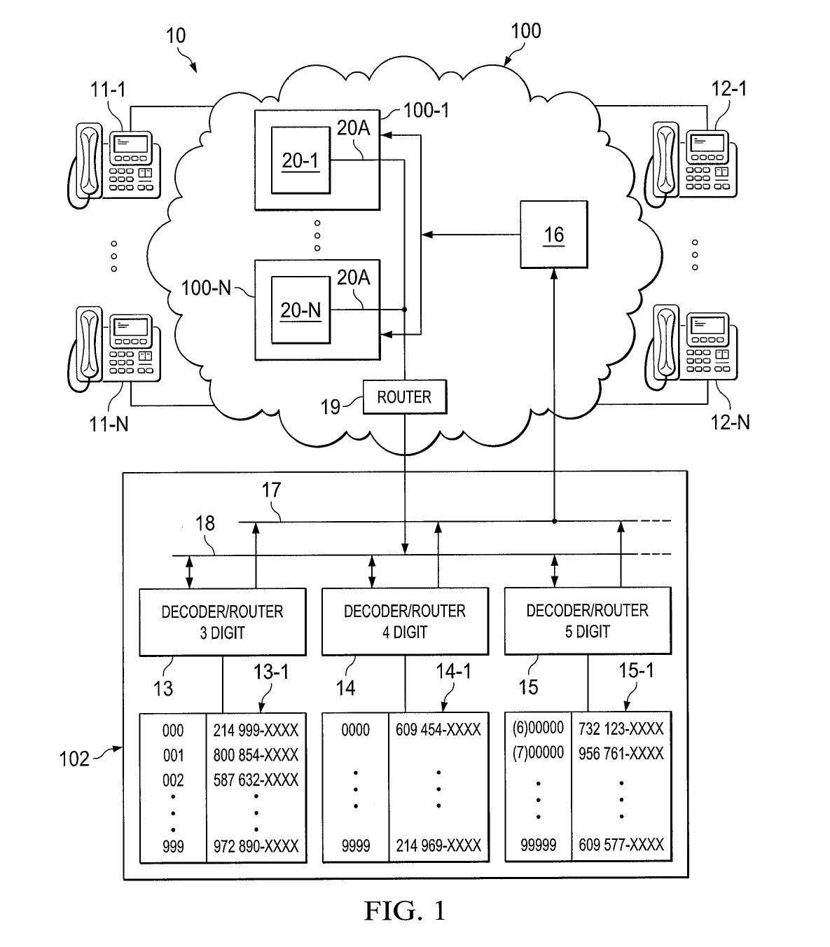

Turning now to FIG. 1, there is shown one embodiment of the application of the concepts discussed herein in a system, such as system 10. As shown, calls can be paced from, or received at, any one of a number of telephones, such as telephones 11-1 to 11-N and 12-1 to 12-N via public switched network 100. Network 100 would typically be a series of interconnected switching centers or a single center. For ease of discussion, a single “cloud” is shown which allows for a more concise discussion of the operation of the concepts discussed herein. However, in actual operation it may be more practical to perform the star-star interception and translation in two or more separate operations. The originating switching point will recognize the non-numeric combination (such as ** or *# or any other unique combination of non-numeric dialed digits) and treat the remainder of the digits as if they were an INWATS call. In such a situation the dialed number, including the unique non-numeric combination, would be forwarded to a CCIS capable translation point for further translation and routing the query and consultation to an SCP database. This would be the first interception.

When the dialed digits arrive at the CCIS capable translation point, and as discussed above, and detailed in the above-referenced Weber Patent, one or more SCPs are used for routing purposes. In the star-star system, as discussed herein, one or more routing centers can also be used, although for purposes of this discussion only one is shown. Depending upon implementation, it is possible to position the star-star translation coextensive with the 800 CCIS capable routing centers or to position the star-star translation at a lesser number of locations or even at a single location.

In operation, dialed digits arriving at a translation SSP point, such as translation point 100-1 (or any translation point 100-N), would be subject to star-star translation via an intercept, such as via circuit 20-1 (to 20-N). The intercept would, as will be discussed, separate out (or intercept) for special processing all calls that have the special unique non-numeric digits contained therein. This is the second intercept in the embodiment being discussed.

The digits pertaining to the intercepted call would then go via the CCIS link, perhaps via a router, such as router 19, to at least one decoding location, such as database system 102, for decoding according to tables established for the star-star decoding. This decoding, in the example being discussed, would be database 13-1 for three-digit calls; database 14-1 for four-digit calls; and database 15-1 for five-digit calls. The determination as to which database to use is, in this example, made by logic in digit decoders/routers 13, 14 and 15. Note that decoders/routers 13, 14 and 15 typically would be a single decoder/router or database, but in some situations, particularly where the various databases 13-1, 14-1 and 15-1 are maintained at different locations (or by different entities) then the decoding can be routed to a proper decoding location. In some situations, the decoding can be performed in parallel and thus the determination as to which database to use can be made at different locations.

For example, assuming a first operating entity controlled the three-digit database; a second operating entity controlled the four-digit database and a third operating entity controlled the five-digit translation, then the databases would likely be at different physical locations and the control for that database would also be at different physical locations. In such a situation, the translation of which database to use following a star-star determination would be made in a distributed fashion.

Returning to the example of FIG. 1, assume the star-star three digit number **002 is detected from a calling stations, such as from calling station 11-1, then decoder 13 would enable database 13-1 to look for the number 002. Note in this example, only three-digit numbers are being used and thus there are no w pre-fix numbers (as will be discussed hereinafter) which determine the length of the calling stream. Database 13-1 then translates the three-digit dialed number 002 into the called parties “real” or POTS number, such as 587,632-XXXX, which, for example, can belong to called party 12-1 or to a series of POTS numbers that may be used for sequential or simultaneous ringing. In this case, each X would have a specific real digit from 0 to 9 associated therewith. Note that when X's are used herein they denote any digit 0 to 9. Likewise, if the star-star three digit 999 were to be detected then the database would translate the dialed **999 into the real number 972 890-XXXX, which could, for example, belong to station 12-N. The real pre-assigned number (which in the U.S. would be the area code, plus office code, plus the four digits of the office, for a total of ten digits) of the target called station (or a pointer to the real number) would then be returned to SSP translator 16 within the traditional routing network via the CCIS link and the call would progress to completion as it would normally have done, except using the translation from database 13-1. Note also that the real number need not be used in the database, but rather an alias 800 number, or any other identification can be used by the database, to signify the proper called station and then the INWATS system would perform its normal translation.

In the situation where variable length star-star translations are possible, then, in one embodiment, the first digit following the star-star digits (w in the above discussion) could indicate the length of the dialed digit. For example, the dialed numbers **40000 and **50000 would each indicate a four-digit number following the initial dialed four or five. By using two length-determining numbers (4 and 5) two different four-digit databases can be used thereby doubling the numbers that are possible. Certainly, only one such length-determining number need be used or more than two could be used, if desired. Using this approach, there would be two databases 14-1, one for the **4XXXX numbers and one for the **5XXXX numbers. These databases can be combined into one if desired. Likewise, the dialed numbers **6XXXXX and **7XXXXX would both be translated by versions of database 15-1. For example, the dialed number **700000 would be translated into 956 761-XXXX by table 15-1 while the dialed number **600000 would result in the translated number of 732 123-XXXX. Again, as discussed, above, the real numbers, or pointers to the real numbers, are translated by the databases and then returned to system 100 for processing as though the real digit had been dialed in the first instance by the calling party.

It is recommended that a given short code, say **XXX, would be used per each country and thus no matter where in the country the call originates it will be connected to the same called station such that **357 dialed from a French phone will be delivered to a French phone who has contracted for the 357 short code. Under such a system, in the U.S. the dialed short code 357 would be delivered to a U.S. based station that has contracted for the U.S. short code 357.

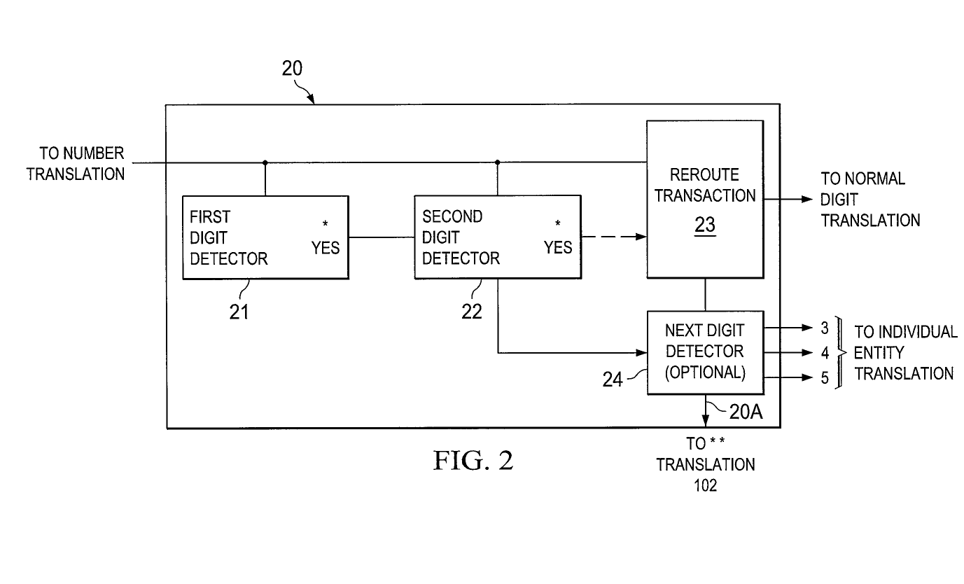

FIG. 2 shows one embodiment of a star-star detect circuit, such as circuit 20 which can be used for one of the circuits 20-1 to 20-N in FIG. 1 to cause the ** dialed numbers to be routed for star-star translation. In this example, first digit detector 21 determines if the first digit is a *. If so, circuit 21 enables circuit 22 to determine if the next digit is also a *. If both circuits 21 and 22 determine that ** has been dialed (received) then circuit 23 is enabled to reroute the translation of the incoming digits from the normal translation to ** translation 102 as previous discussed. In situations were different entities are responsible for translating different dialing code lengths then star-star detector circuit would advantageously have option routing via next digit detector 24 which would determine the value of the next digit and send the remaining digits to the appropriate entity for translation depending upon which digit follows the **. Note here that when multiple digits (such as a 6 or 7) both indicate that five more digits will follow it is possible to further separate the translation entity by whether the next digit following the ** is a detected 6 or a detected 7, if desired.

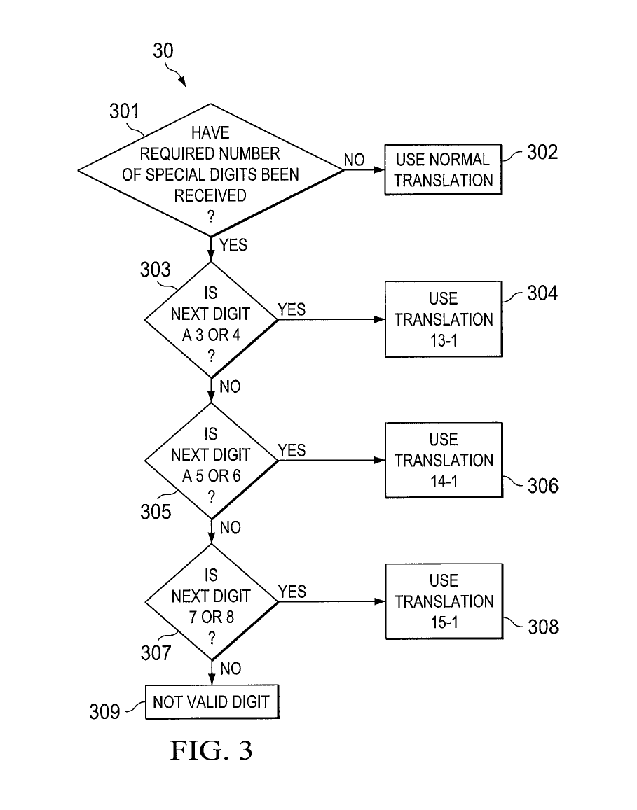

FIG. 3 shows one embodiment of a method, such as method 30, for controlling telephone routing using short code dialing. Process 310 determines if the proper special first digits, such as **, have been received. If not, then the dialed number is processed normally as discussed herein.

If ** has been detected, and assuming a variable length short code, then process 303 determines if the first digit after the ** is a 3 or 4. If so, then process 304 directs the translation to the three-digit translation, such as database 13-1, FIG. 1. In situations were the three-digit translation is performed by a specific entity then the numbers that require translation are sent to that special entity for translation. As discussed, two (or more) different entities can translate three-digit numbers, thus in such situations, if the digit after the ** is a 3 the digit stream can be translated by one entity and if the digit after the ** is a 4 the digit stream can be translated by a different entity, all under control of process 304 if desired.

If process 303 determines that neither a 3 or a 4 followed the ** then processes 305 determines if a 5 or 6 has been received as the next digit after the **. If so, then process 306 handles translation in the same manner as was handled by process 304.

If process 305 determines that neither a 4 or a 5 followed the ** then processes 307 determines if a 7 or 8 has been received as the next digit after the**. If so, then process 308 handles translation in the same manner as was handled by process 304.

Note that processes 303, 305 and 307 can be performed in parallel based upon a determination by process 301 that a ** has been received. As noted, the determinations by processes 303, 305 and 307 can be made at a central location or at physically diverse locations and can operate autonomously.

Each such station is depicted as an individual telephone station for the purpose of illustration. However, it is to be understood that in many cases short code call answering facilities will commercially utilize automatic call distributor systems involving numerous groups of incoming telephone lines served by a local or toll telephone switching system. A typical distributor system is disclosed, for example, in S. F. Dunning U.S. Pat. No. 3,111,561 of Nov. 19, 1963, which is hereby incorporated by reference herein. In addition, the owner of the short code may be interested that there will be a simultaneous ring at different numbers and the one that answers the call first gets the call or that in case there is no answer while ringing the first sequential number, within a certain programmable period of time, that another number in the series sequence will be dialed and so on, until possible routing the call to a Voice Messaging system or an Answering Service.

In some situations, it may be desirable to deliver the short code call to a particular called station depending upon the location of the originating caller. After station 11-1 initiates a call and dials the short code customer number, system 100-1, with the help of circuits 20-1 to 20-N, recognizes the short code call prefix (**) followed by the 4 to 6 digits short code and routes the call illustratively over a trunk, with the assistance of number translation from database 102, to a toll office equipped with CCIS facilities. The system also forwards the area code for the location from which the call originates. Structure and operations of CCIS are all now well-known and described, by way of example, in 57 Bell System Technical Journal No. 2, page 230, et seq.

System 102, in conjunction with systems 100-1 and 16 are responsive to the received short code number and originating area code for deriving all of the stored information needed for processing the call to an idle and available short code customer station designed as the assigned called station to serve the call. The information includes data for the active-inactive status of the dialed short code number, the storage files associated with the active number, the inband/out-band character of the call based on the received originating area code, and a directory POTS number of a destination subsystem or station. Short codes can be 800 calls in that they are “free” to the calling party or they can be regular calls. In the case of 800 calls, one embodiment provides that the number returned from database 102 is an 800 number or the number that stands behind it (such as would be the case if the short code **3001 had been dialed) which is then processed in the well-known manner.

System 102 is equipped with translator tables containing a list of originating area codes and a correlated list of POTS DDD (Plain Ordinary Telephone Service Direct Distance Dialing) numbers identifying one or more called stations primarily designated to serve calls from the respective originating areas. As a possible enhancement, it is possible that instead of one POTS DDD number there will be a series of numbers and also the indication of whether to simultaneously ring these numbers or sequentially do it. In case of sequential, there could also be that at the end of the list, a routing to a Voice Messaging system or an answering service. Each listed area code is uniquely associated with an individual one of the listed POTS numbers when the short code customer is entitled to receive calls from that originating area on a toll-free basis to the calling party. A single such POTS number may be shared by a plurality of different originating area codes. Whenever the tables in system 102 contain a POTS number for an originating area code, calls from that area are designated as being “in-band”. Otherwise, in the absence of a POTS number for the area code, (null entry) calls from that area are “out-of-band” for the short code customer and calls are not completed on a toll free basis to the caller.

If desired, short code calling can be used for reverse charges to the called number. In such a situation, one entire block of numbers, for example all four-digit numbers, or all variable length numbers starting with, say a five, will be translated as, in one example, 900 numbers. While short codes have been discussed herein for telephone call routing they can also be used for SMS message routing as well using the public switched telephone network.

One business model for utilizing the short code routing discussed herein would be to have a short code provider entity that controls a particular length, say **XXXX, charge a premium for the use of a particular number. This then would allow a person, or business, to have an easily remembered four digit number that will allow to access its main PABX's number. When variable length numbers are used, different operating entities could, if desired, handle different length numbers. Thus, by way of example, operating entity A could charge a certain amount per year for a three digit number of the style **XXX (of which there would only be 1000) and operating entity B could charge a lesser amount per year for a four digit number of the style **XXXX (of which there would only be 10,000). As discussed above, each entity A and B could, if desired, control their respective databases for translation purposes or one or both could have the SCP perform the translation under control of a database supplied by entities A and B.

Note that while the embodiment shown herein contemplates an intelligent network protocol (INAP) it is to be understood that any type of network can be used, including, for example, a Softswitch network using SIP protocol.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A public switched telephone network routing system comprising:
at least one detection circuitry for determining telephone network calling connections to a called party initiated using as a prefix and discriminating sequence, a unique combination of non-number dialed digits;
circuitry responsive to receipt of dialed digits pertaining to a detected calling connection having said unique combination of non-number dialed digits for accepting an expected number of dialed digits pertaining to said calling connection, said expected number of dialed digits being less than a full compliment of dialed digits required to complete a calling connection to said called party; and
circuitry for enabling said full compliment of digits to be supplied to said telephone network so that said calling connection can be completed through said telephone network to said called party.

2. The routing system of claim 1 wherein said enabling circuitry comprises at least one database.

3. The routing system of claim 2 further comprising:
means based at least in part on an identity of digits received as part of said received dialed digits for determining said expected number of dialed digits.

4. The routing system of claim 3 wherein said non-number dialed digits are selected from a list of: star, pound.

5. The routing system of claim 1 further comprising:
circuitry for routing received dialed digits to a location remote from said telephone network switching point upon detection of calling connections to a called party initiated using a unique combination of non-number dialed digits; wherein said enabling circuitry comprises at least one database located at said remote location and wherein said non-number dialed digits are selected from a list of: star, pound.

6. The routing system of claim 5 wherein:
circuitry based at least in part on an identity digits received as part of said received dialed digits for determining said expected number of dialed digits; and
circuitry for routing received dialed digits to different locations remote from said telephone network switching point based upon a determined expected number of dialed digits; and wherein said enabling circuitry comprises at least one database located at a remote location to which said dialed digit have been routed.

7. A method of competing calls in a telephone system in which calls are routed from a calling station to a called station under control of digits dialed from said calling station, said digits representative of a pre-established numeric telephone number having a fixed number N of numeric digits, said method comprising:
detecting a calling station short code dialed called number containing a specific combination of non-numeric dialed digits as well as numeric digits representative of a called station, said detected numeric digits being less than N; and
sending said detected short code number to at least one short code translation table separate from a translation table used for INWATS translation such that a telephone connection can be established from said calling station to said called station under control of said detected short code dialed number.

8. The method of claim 7 wherein said non-numeric dialed digits are selected from the list of: star, pound.

9. The method of claim 8 wherein a length of said calling station short code is L digits, said method further comprising:
determining L based on a value of a first digit following said specific combination of non-numeric dialed digits.

10. The method of claim 8 wherein a length of said calling station short code is L digits, said method further comprising:
determining L based on a position of a non-numeric dialed digit in said short code dialed called number.

11. The method of claim 8 wherein a length of said calling station short code is L digits, said method further comprising:
selecting said translation table based on a determined value of L.

12. The method of claim 11 further comprising:
determining L based on a value of a first digit following said specific combination of non-numeric dialed digits.

13. The method of claim 11 further comprising:
determining L based on a value of at least one digit in said short code.

14. A method for using short code dialing in a telephone network, said method comprising:
routing calls from a calling station to a called station or to a series of called numbers under control of a fixed length calling number pre-assigned to said called station, said fixed length being N numeric digits; and
routing calls from a calling station to a called station under control of a short code number dialed from said calling station, said short-code identified by a pre-assigned combination on non-numeric digits in said dialed number.

15. The method of claim 14 wherein said short code routing comprises:
translating between a received short code and a corresponding fixed length pre-assigned number of said called station.

16. The method of claim 15 wherein said short code number is of variable length V.

17. The method of claim 16 wherein length V is determined based upon values of certain digits within said short code.

18. The method of claim 17 wherein said short code routing comprises:
sending received short codes to a particular database to obtain translation to said corresponding fixed length station number, said particular database depending upon said determined length V.

19. The method of claim 18 wherein at least some of said particular databases are located at separate physical locations from each other.

20. A method for using short code dialing in a telephone network, said method comprising:
routing calls from a calling station to a called station or to a series of called stations under control of a fixed length calling number pre-assigned to said called station, said fixed length being N numeric digits; and
routing calls from a calling station to a called station under control of a short code number dialed from said calling station, said short-code identified by a pre-assigned combination on non-numeric digits in said dialed number, said short code routing comprising:
translating between a received short code and a corresponding fixed length pre-assigned number of said called station under control of a database maintained independent of said telephone network by a short code provider.

21. The method of claim 20 wherein said short code number is of variable length V wherein length V is determined based upon values of certain digits within said short code.

22. The method of claim 21 wherein said short code provider is determined by a determination of said variable length V.
